(19) United States
(12) Patent Application Publication
(10) Pub. No.: US 2005/0211524 A1
(43) Pub. Date: Sep. 29, 2005

(54) Clutch assembly with smooth engagement

(76) Inventors: James H. DeVore, Laurinburg, NC (US); Charles E. Allen JR., Rochester Hills, MI (US); Winfried Sturmer, Euerbach (DE); Karl-Fritz Heinzelmann, Meckenbeuren (DE); Ludger Ronge, Eriskirch (DE); Loren C. Dreier, Vass, NC (US); Robert A. Sayman, Laurinburg, NC (US); Ronald P. Muetzel, Friedrichshafen (DE); Muneer AbuSamra, Southern Pines, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/808,150

(22) Filed: Mar. 24, 2004

(51) Int. Cl. B60K 41/22

(52) U.S. Cl. 192/3.63; 192/30 W

(57) ABSTRACT

A clutch assembly controller monitors initiation points for torque transfer and clutch lockup to determine a clutch engagement rate. Engine output shaft and transmission input shaft speeds are monitored to determine the points at which the torque transfer and clutch lockup begin. These points are stored as reference points and are updated as the clutch wears over time. The clutch engagement rate is also modified over time as the reference points change. Further, the controller utilizes the reference points to approach the desired clutch engagement and disengagement points at a higher rate of speed to optimize responsiveness while automatically changing to a lower rate of speed once operating in the desired region of interest to optimize clutch operating performance and comfort.

### BACKGROUND OF THE INVENTION

This application generally relates to vehicle clutch assemblies. More particularly, this invention relates to clutch assembly that automatically adjusts clutch engagement and disengagement response times to compensate for lag and wear.

A variety of vehicle transmissions are available currently in the market. Some transmissions are automated and do not require operator input other than selecting a gear mode, for example, reverse or drive. Other transmissions are manual and require manual operation of a gear shift lever to manually move transmission components into selected gear ratios. In manual transmission configurations, a clutch assembly is needed to engage and disengage a transmission input shaft from the engine output shaft in order to move between gear ratios. This typically occurs by a manual actuation of a clutch pedal to eliminate the connection between the engine output shaft and the transmission input shaft. Manual clutch pedal actuation is typically required each time that a shift in gears is desired.

There have been many attempts to simplify and improve the operation of manual transmissions and clutches. Even with such improvements, those skilled in the art are always striving to make these systems operate more efficiently and to provide a smoother, more comfortable ride. One problem that has not been fully addressed relates to clutch actuation characteristics.

Traditionally, clutch systems have variable actuation characteristics that result from manufacturing, installation, wear, and environmental factors. As a result of these factors, an open clutch has a lag between the generation of a closure command and the actual closure response. Similarly, a closed clutch has a lag between the generation of an open command and the actual open response. These open and close lags vary between each clutch assembly. Further, as the clutch closes, the length of the region between the start of torque transfer and the completion of full torque transfer, i.e. a fully closed clutch, varies from one clutch to another.

Ideally, to eliminate this variation, each clutch system would be calibrated to correspond to the characteristics of the mating clutch components. However, this is not practical as the process would be expensive and time consuming. Further, the solution does not address the problem of component wear over time.

Another solution involves ramping the open and close commands at a fixed rate for movement in the lag areas and movement through the torque transfer area. The ramped rate is typically selected as a compromise rate that provides acceptable levels of comfort and response. This solution is also unsatisfactory because neither comfort nor response is fully optimized for the system, as the ramped rate merely attempts to minimize the trade-off effects between comfort and responsiveness.

There is a need for a clutch engagement system that provides smoother and more responsive clutch engagement and disengagements, and which can automatically compensate for wear and service events that occur over time as well as overcoming the other above-mentioned deficiencies in the prior art.

### SUMMARY OF THE INVENTION

A clutch controller modifies clutch engagement rates over time to optimize clutch responsiveness and performance. The clutch controller monitors engine output shaft speed and transmission input shaft speeds to determine reference points at which torque transfer and clutch lockup begins. The controller determines the clutch engagement rate based on these reference points.

In one disclosed embodiment, the reference points are monitored over time and saved in long-term memory. The clutch engagement rate is modified or updated based on changes in the reference points. This provides for more consistent responsiveness and performance as clutch components wear.

In one disclosed embodiment, the controller utilizes the reference points to determine varying engagement rates for optimizing responsiveness and for optimizing performance. By determining the reference points for torque transfer and clutch lockup, the controller can approach desired engagement and disengagement points at a high rate of speed to improve response. The controller automatically changes the rate of speed once the clutch is operating in the desired range to improve operating comfort and performance.

In another disclosed embodiment, the controller modifies the clutch engagement rates to achieve consistent vehicle acceleration behavior during drive-off. The controller determines an amount of torque necessary for initiating vehicle movement and determines the torque increase rate needed for the desired vehicle acceleration. The amount of torque and the torque increase rate are determined by considering factors such as vehicle rate, drive-off gear, and gradient.

The subject invention provides more efficient and consistent clutch control over time. These and other features of the present invention can be best understood from the following specification and drawings, the following of which is a brief description.

### BRIEF DESCRIPTION OF THE DRAWINGS

FIG. 1 is a schematic diagram of one embodiment of a transmission incorporating the subject invention.

FIG. 2 is a schematic diagram of an electronic shift transmission incorporating the subject invention.

FIG. 3 is a schematic diagram of a mechanical centrifugal clutch as used with the transmission of FIG. 1.

### DETAILED DESCRIPTION OF THE PREFERRED EMBODIMENT

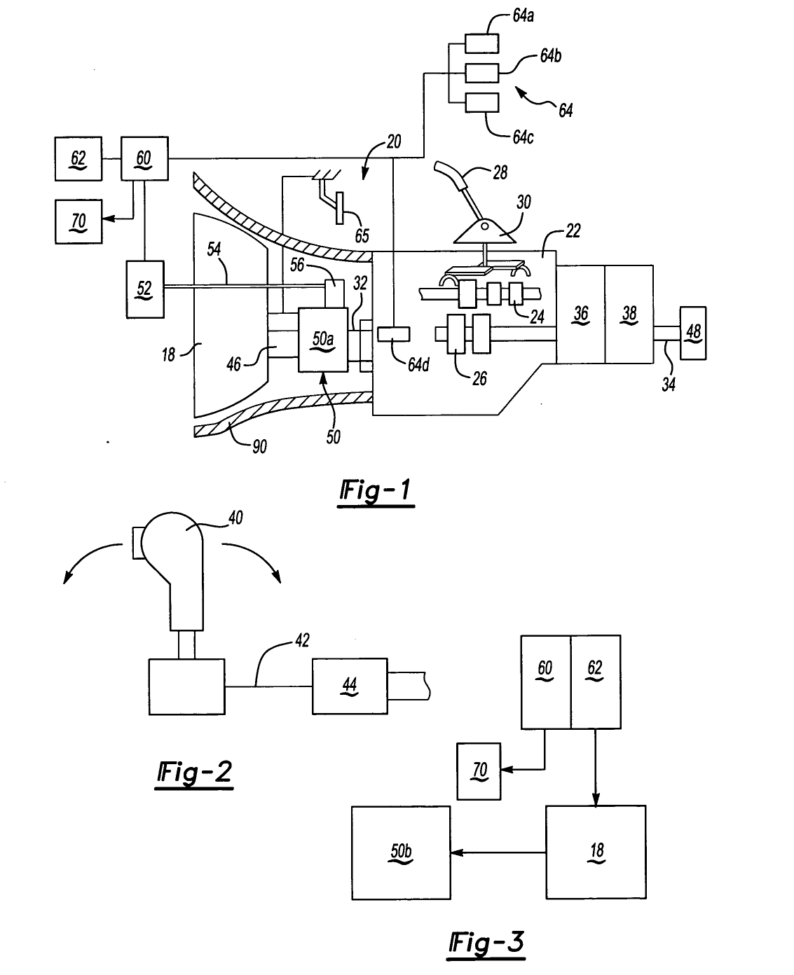

FIG. 1 diagrammatically illustrates an engine 18 and a transmission system 20 including a main gear box 22 that has a plurality of gear members 24 and 26. In the illustrated embodiment, a manually operable shift lever 28 is moveable about a pivot point 30 to manually, selectively engage one of the gear members 24 and 26 to achieve a desired gear ratio between a transmission input shaft 32 and a transmission output shaft 34.

The transmission system 20 can include a splitter gear assembly 36 to provide additional gear ratios between the ratios provided by gear members 24, 26 in the main gear box 22, or a range gear box 38 to provide additional gear ratios greater than the ratios provided by gear members 24, 26. The operation of range gear boxes 38 and splitter assemblies 36 are well known in the art and will not be discussed in detail. In some instances the use of a range gear box 38 or a splitter assembly 36 may not be necessary.

Additionally (as schematically illustrated in FIG. 2), this invention is applicable to transmissions having a shift lever 40 that generates electrical signals 42 indicating a desired gear, the signals 42 being communicated to an automated gear moving mechanism 44 that automatically moves the gear members into a position to achieve the desired gear ratio indicated by the generated electrical signal 42. The manual shift lever is illustrated but not required for implementing this invention.

The transmission input shaft 32 receives a driving force from an engine output shaft 46, which is operably coupled to the engine 18. The transmission output shaft 34 provides a driving force to a vehicle drive assembly 48. The drive assembly 48 typically comprises a vehicle driveshaft coupled to a drive axle assembly that includes a center differential, which drives a pair of axis shafts coupled to a pair of vehicle wheel ends.

The transmission input shaft 32 is coupled to the engine output shaft 46 through a clutch assembly 50. The clutch assembly 50 can be a “dry clutch” or a “wet clutch” as is generally known in the art. The clutch assembly 50 can also be a centrifugal clutch, releaser clutch, or any other known clutch mechanism.

In one example, the transmission system 20 includes a clutch 50a with an automated clutch operator 52 having a moving member 54 that operates a clutch engagement member 56. The clutch engagement member 56 moves the clutch 50 between a non-engaged or open position and an engaged or closed position. In the non-engaged position, driving torque is prohibited from being transferred from the engine output shaft 46 to the transmission input shaft 32. In the engaged position, driving torque is transferred from the engine output shaft 46 to the transmission input shaft 32.

The automated clutch operator 52 can be electrically powered (including a solenoid, for example), hydraulically powered, or pneumatically powered depending on the desired clutch configuration. Automated clutch actuators are known in the art and those skilled in the art will be able to choose from among known components to realize an automated clutch operator 52 that operates as described in this specification.

In another example, shown in FIG. 3, the clutch 50 comprises a fully mechanical centrifugal clutch 50b. As known, the centrifugal clutch 50b utilizes a centrifugal activation force to engage the clutch. The structure and operation of mechanical centrifugal clutches are well known in the art, and thus will not be discussed in detail.

In either example, the clutch 50 utilizes a controller 60 to directly or indirectly control clutch engagement. In the example shown in FIG. 1, the electronic controller 60 directly controls the operation of the automated clutch operator 52. The electronic controller 60 preferably communicates with an engine controller 62, to gather information regarding the operating condition of the vehicle engine. The electronic controller 60 and engine controller 62 can be any commercially available microprocessor programmed to function as needed to achieve the results of this invention. Engine controllers are well known in the art. Although the controllers 60 and 62 are schematically illustrated as separate devices, they both can be portions of a single microprocessor.

In the example shown in FIG. 3, the controller 60 indirectly controls clutch engagement by controlling the speed of the engine 18 via the engine controller 62. As discussed above, the controller 60 can be separate from the engine controller 62 or can be combined into the engine controller 62 to form a single control unit.

In either configuration, the electronic controller 60 also preferably communicates with a sensor assembly, shown generally at 64, which monitors and measures a plurality of vehicle conditions. The electronic controller 60 gathers information from the sensor assembly 64 to determine a clutch engagement speed. Preferably, the sensor assembly 64 includes at least an engine output shaft speed sensor 64a and a transmission input shaft speed sensor 64b. Other sensors 64c known in the art could also be used as required.

By monitoring the engine speed and the transmission input shaft speed, the points at which torque transfer begins and clutch lockup begins can be easily determined. In the example of a centrifugal clutch assembly having generally fixed clutch characteristics, these torque transfer and clutch lockup points could be determined in terms of engine revolutions per minute (rpm). Both the torque transfer point and the clutch lockup point comprise system reference points. The controller 60 determines the clutch engagement rate based on these reference points.

The controller 60 monitors these reference points over time and saves the reference points in long-term memory in the controller 60. The reference points change or are updated over time as the clutch assembly 50 is serviced or as clutch components wear over time. The controller 60 modifies or updates the clutch engagement rate as these reference points change over time.

Optionally, the controller 60 performs plausibility or diagnostic checks to verify that the reference points and corresponding clutch engagement rates make sense in light of the general vehicle operating conditions. These checks are preferably logged within the controller 60 and can be used to modify the clutch engagement rates as needed. Further, the controller 60 could warn the operator that one of the reference points or clutch engagement rate is not plausible or does not make sense in light of the vehicle operating conditions by using any type of visual or audible warning device 70, including displays, warning lights, or buzzers, for example. If the plausibility check fails or otherwise indicates a system fault, the controller 60 could modify the clutch engagement rate to a default value or other predetermined value.

By monitoring the torque transfer and clutch lockup initiation points over time, the controller 60 can automatically vary the engagement rate to optimize both clutch responsiveness and clutch operating performance and comfort. The controller 60 preferably utilizes the reference data to approach desired clutch engagement and disengagement points at a high rate of speed to optimize clutch responsiveness. The controller 60 automatically changes to a different rate of speed once the vehicle and clutch/transmission system are operating in the desired region of interest, which optimizes comfort and performance. Preferably the controller 60 decreases the rate of speed for clutch engagements and disengagements to maximize comfort and performance.

The controller 60 also uses the reference data to achieve consistent vehicle acceleration behavior during drive-offs. The controller 60 determined the amount of torque needed to initiate vehicle movement and determines the torque increase rate for the desired vehicle acceleration. These torque and torque rate determinations are based on such factors as actual vehicle weight, actual drive-off gear, actual drive-off gradient, and/or any other such factors known in the art. The controller 60 utilizes the torque and torque rate determinations to modify the clutch engagement rates. By considering these factors in the engagement and disengagement strategy, a minimum response time and maximum drive-off comfort are achieved.

As discussed above, the controller 60 monitors the changes in the reference data and the modified clutch engagement speeds over the life of the clutch assembly 50. The controller 60 can use this information to predict the useful life of the clutch assembly 50. The controller 60 can periodically warn or advise the vehicle operator that service is required. This allows the vehicle operator to perform service operations as need, avoiding expensive component failures a vehicle down time.

The subject invention provide for improved clutch engagement disengagements controls. The clutch control modifies clutch engagement rates over time to achieve consistent clutch performance over time as components are serviced or wear. Although a preferred embodiment of this invention has been disclosed, a worker of ordinary skill in this art would recognize that certain modifications would come within the scope of this invention. For that reason, the following claims should be studied to determine the true scope and content of this invention.

1. A method for controlling clutch engagements comprising the steps of:
(a) monitoring engine output shaft speed;
(b) monitoring transmission input shaft speed;
(c) generating a clutch operational command to open or close a clutch assembly;
(d) determining a first reference point corresponding to a beginning of torque transfer in response to the clutch operational command based on at least data from steps (a) and (b);
(e) determining a second reference point corresponding to a beginning of clutch lockup based on at least data from steps (a) and (b); and
(f) determining a clutch engagement rate based on the first and second reference points.

2. The method of claim 1 further including the steps of storing the first and second reference points in long-term memory, updating the first and second reference points over time to provide corrected first and second reference points, and adjusting the clutch engagement rate based on the corrected first and second reference points.

3. The method of claim 1 further including the step of updating the first and second reference points over time in response to clutch component wear.

4. The method of claim 1 further including the step of updating the first and second reference points in response to a service event.

5. The method of claim 1 further including the step of determining the first and second reference points in terms of engine revolutions per minute.

6. The method of claim 1 further including the step of performing a plausibility check to verify at least one of the first reference point, second reference point, or clutch engagement rate.

7. The method of claim 6 including the step of generating a warning signal if the plausibility check fails.

8. The method of claim 6 including the step of modifying the clutch engagement rate if the first reference point, second reference point, or clutch engagement rate is not plausible.

9. The method of claim 1 wherein step (f) further includes optimizing clutch engagement response by approaching engagement and disengagement points at a first rate of speed.

10. The method of claim 9 wherein step (f) further includes optimizing clutch operating comfort and clutch performance by changing to a second rate of speed different than the first rate of speed once the clutch assembly is operating in a desired region.

11. The method of claim 10 wherein the first rate of speed comprises a higher rate of speed than the second rate of speed.

12. The method of claim 1 including the steps of determining drive-off torque and determining associated drive-off torque increase rate for a desired vehicle acceleration prior to initiating a drive-off maneuver.

13. The method of claim 12 determining the drive-off torque and drive-off torque increase rate based on at least one of vehicle weight, drive-off gear ratio, or drive-off gradient.

14. The method of claim 12 further including the step of modifying the clutch engagement rate based on at least one of the drive-off torque and drive-off torque increase rate.

15. The method of claim 1 further including the steps of monitoring and storing the first and second reference points over time to generate a clutch history, and predicting a useful clutch life based on the clutch history.

16. The method of claim 15 including the steps of generating periodic clutch status signals to advise a vehicle operator that service is required.
